(19) United States
(12) Patent Application Publication
(10) Pub. No.: US 2006/0141147 A1
(43) Pub. Date: Jun. 29, 2006

(54) Adhesive tape and producing method thereof

(75) Inventors: Nobuo Sugiyama, Kanagawa (JP); Masahisa Yamaguchi, Tokyo (JP); Jun Inose, Kanagawa (JP)

Correspondence Address: SUGHRUE MION, PLLC, 2100 PENNSYLVANIA AVENUE, N.W., SUITE 800, WASHINGTON, DC, 20037, US

(73) Assignees: FUJI PHOTO FILM CO., LTD.; DAI NIPPON PRINTING CO., LTD.

(21) Appl. No.: 11/360,475

(22) Filed: Feb. 24, 2006

Related U.S. Application Data
(62) Division of application No. 10/878,367, filed on Jun. 29, 2004.

(30) Foreign Application Priority Data
Jun. 30, 2003 (JP) 2003-186490

(51) Int. Cl. B05D 5/10

(52) U.S. Cl. 427/208.6; 427/207.1; 427/208.2

(57) ABSTRACT

A closing tape prevents winding looseness of a roll photo film and a light-tight sheet which are wound around a spool. After an adhesive agent layer formed on one end of the closing tape is adhered to a surface of the light-tight sheet, an adhesive agent layer formed on the other end of the closing tape is adhered to a surface of the closing tape. The adhesive agent layer consists of multiple adhesive dots. The respective dots are formed by heat sensitive adhesive agent filled in the respective cells of a gravure roll to coat on the closing tape by gravure coating. Adhesive force is stabilized due to uniformity in size and thickness of the dots. Moreover, the cells are provided at same intervals and heat sensitive adhesive agent having optimum viscosity is used, so that the adjacent dots are prevented from connecting each other.

This is a divisional of application Ser. No. 10/878,367 filed Jun. 29, 2004, the entire disclosure of the prior application, application Ser. No. 10/878,367 is hereby incorporated by reference.

### FIELD OF THE INVENTION

The present invention relates to an adhesive tape and producing method thereof, and more particularly, relates to an adhesive tape which is preferable for sealing a roll photo film.

### BACKGROUND OF THE INVENTION

There is a Brownie film as a roll photo film. The Brownie film includes a strip-shaped photo film, a light-tight sheet which is slightly wider than the photo film, and aplastic spool. The photo film and the light-tight sheet are wound around the spool, in a manner that the light-tight sheet is placed on the outermost periphery. A closing tape or retaining tape is stuck on the periphery of the light-tight sheet, for preventing winding looseness.

The closing tape consists of a strip-shaped support member which is longer than the periphery length of the roll film, and adhesive layers provided on both sides on one surface of the support member. After an adhesive layer provided on one side of the support member is adhered to one end of the light-tight sheet, the other side of the support member is wound on the periphery of the roll film. The adhesive layer disposed on the other side of the support member is adhered to the back surface thereof, so that the closing tape seals the photo film and the light-tight sheet.

The closing tape is adhered to the periphery of the roll film after the photo film and the light-tight sheet are wound around the spool. Therefore, it is possible to use pressure sensitive type of adhesive agent for a closing tape, but it is not recommendable since pressure marks occur on the photo film when applying strong pressure to the closing tape. The roll film sealed by the closing tape is housed in a packaging bag having light-tight and moisture-proof properties. There are some types of adhesive agent which adversely affect photographic properties in the packaging bag being sealed. Moreover, adhesive agent having adhesive force unchangeably at all the times makes it difficult to handle the closing tape, in which adhesive agent is likely to be extruded from the lower side of the support member at the adhering. From the circumstances mentioned above, heat sensitive adhering is used for the adhesive layer of the closing tape, which is not adhesive in a normal state, capable of activating adhesive agent without pressure, and not likely to affect photo property after adhering.

For example, JP-A 10-080660 discloses that heat sensitive adhesive agent of a closing tape is coated on a support member by gravure coating. Heat sensitive adhesive agent used for gravure coating is dissolved in solvent to obtain liquidity, to be coated on the base paper of the support member by a gravure roll. It is well known that the gravure roll used for gravure coating is formed with multiple cells in a recessed shape, for holding heat sensitive adhesive agent on the roll. When heat sensitive adhesive agent in the cells is transferred to the support member, heat sensitive adhesive agent in the respective cells uniformly spreads out and connects each other, to form the adhesive layer having entirely uniform thickness.

However, in gravure coating, flow is produced in heat sensitive adhesive agent at the leveling, and heat sensitive adhesive agent does not spread out uniformly. Therefore heat sensitive adhesive agent transferred from the cells irregularly connects each other, to occur unevenness of the adhesive layer in thickness. This phenomenon of the uneven thickness is a defect of coated surface. When the uneven thickness is generated in the adhesive layer, adhesive force of the closing tape is not uniformized, the closing tape is likely to be peeled off from a portion having the weakest adhesive force.

### SUMMARY OF THE INVENTION

An object of the present invention is to uniformize adhesive force of an adhesive tape used for sealing throughout coating area.

To achieve the above objects, an adhesive tape of the present invention includes a support member having a coating area on at least one surface thereof and an adhesive layer coated with dotted adhesive agent on the coating area. The adhesive agent has an area which is 55-93% of the coating area. The each dot of the adhesive agent has an area of 0.5 mm² or more. The adhesive layer has a thickness of 5 μm or more. The adhesive agent is heat sensitive adhesive agent. Such an adhesive tape is preferably used as a sealing tape for sealing a strip-shaped photo film and a light-tight sheet which are wound around a spool.

The adhesive tape is produced by coating the adhesive agent on a gravure coater, pressing the support member to the gravure coater having dotted pattern, to transfer the dotted adhesive agent to the support member. Each dot of the adhesive agent corresponds to each cell of the gravure coater. The adhesive agent is heat sensitive adhesive agent. The adhesive agent has a viscosity, measured using a No. 5 Zahn cup viscometer, in a range from 11 to 14 seconds at the applying of the adhesive agent. The gravure coater includes ridges for partitioning cells adjacent each other, in which the ridges are one tenth or more in width compared to each of the cells.

According to the present invention, since adhesive agent is coated in the form of dots, adhesive force in the coating area is uniformized, so that it is possible to improve adhesive property of the tape. Moreover, it is possible to prevent adjacent dots from being connected each other by controlling viscosity of adhesive agent and intervals between the respective cells of the gravure coater.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a perspective view illustrating a roll photo film of the present invention;

FIG. 2 is a plan view illustrating a closing tape;

FIG. 3 is a fragmentary sectional view illustrating a roll photo film;

FIG. 4 is a schematic diagram illustrating a structure of a gravure coating apparatus;

FIG. 5 is an explanatory view illustrating an dimension and arrangement of the cells and ridges of a gravure roll;

FIG. 6 is a fragmentary sectional view illustrating a gravure roll;

FIGS. 7A-7C are plan views illustrating a base paper on which heat sensitive adhesive agent is coated; and

FIG. 8 is a fragmentary sectional view illustrating a closing tape.

### DESCRIPTION OF THE PREFERRED EMBODIMENTS

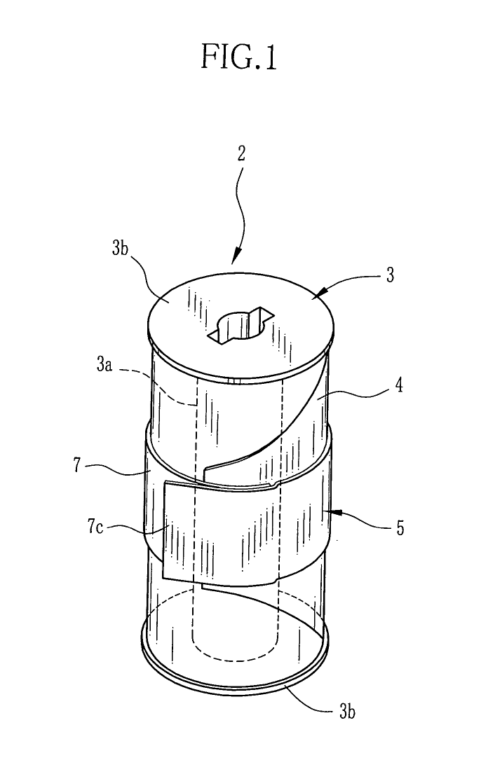

FIG. 1 is a perspective view illustrating an external shape of a roll photo film of the present invention. A roll photo film 2 includes a spool 3, a strip-shaped photo film, a strip-shaped light-tight sheet 4 and a strip-shaped closing tape 5. The spool 3 is integrally formed with an axis 3a and a couple of flanges 3b provided at the both ends of the spool 3a. The photo film is wound around the axis 3a of the spool 3. The light-tight sheet 4 is wound on the periphery of the photo film, for shielding the photo film against the light. The closing tape 5 is wound on the periphery of the light-tight sheet 4, and the both ends of which are adhered to the light-tight sheet 4.

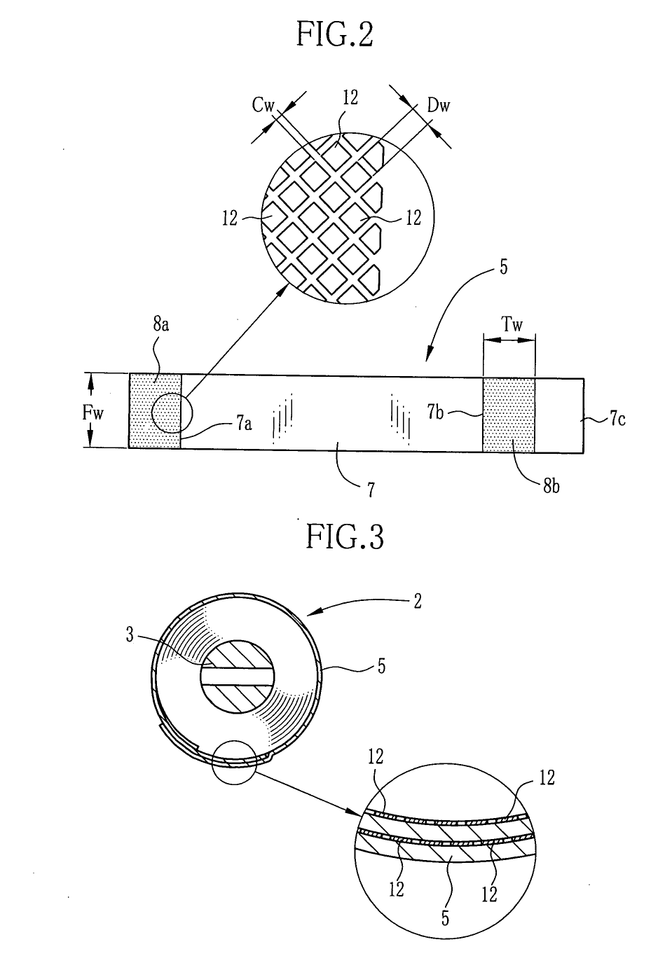

FIG. 2 is an exploded view illustrating the closing tape 5. The closing tape 5 includes a strip-shaped support member 7 formed by such as a paper material, heat sensitive adhesive layers 8a and 8b provided at the both sides on one surface of the support member 7. The support member 7 includes an edge portion 7c provided outside the adhesive layer 8b, in which the edge portion 7c is used when the closing tape 5 is peeled off from the periphery of the light-tight sheet 4. While having no adhesive force at normal temperature, heat sensitive adhesive agent is activated to have adhesive force when heated at the predetermined temperature. Therefore it is easy to be handled before adhering.

The adhesive layer 8a provided at one end of the closing tape 5 is overlaid on one end of the light-tight sheet 4 wound around the spool 3, heated at the 120-140 degrees by such as a heater and adhered to the light-tight sheet 4. Thereafter, the other end side (free end side) of the closing tape 5 is wound on the periphery of the light-tight sheet 4, the adhesive layer 8b provided at the other end of the closing tape 5 is overlaid on the back surface of the support member 7 of the closing tape 5, to be heated and adhered in a similar manner with the adhesive layer 8a. Therefore, winding looseness of the light-tight sheet 4 is prevented. It is noted that heating of the adhesive layer at the time of adhering is completed in a short period of time, thereby there occurs no thermal fog.

The adhesive layers 8a and 8b of the closing tape 5 consist multiple adhesive dots 12. Therefore, shown in FIGS. 1 and 3, the closing tape 5 attached on the periphery of the roll photo film 2 is adhered to the periphery of the light-tight sheet 4 by the respective adhesive dots 12.

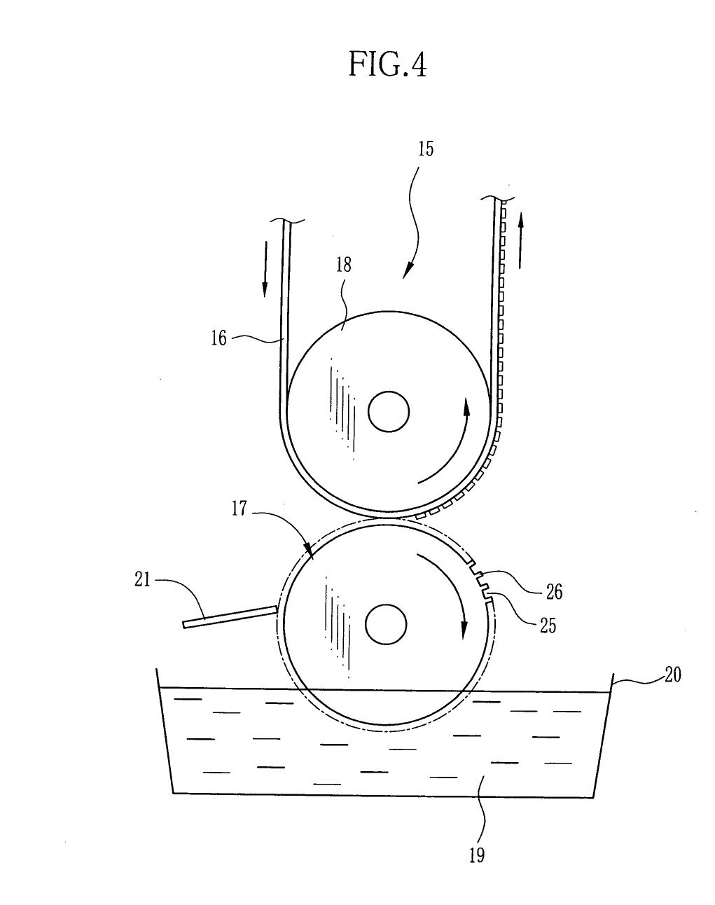

The adhesive layers 8a and 8b of the closing tape 5 is formed by a gravure coater 15 or a gravure coater shown in FIG. 4. The gravure coater 15 includes a gravure roll 17, a backup roll 18, a coating liquid pan 20 and a doctor blade 21. The gravure roll 17 transfers heat sensitive adhesive agent onto a base paper 16 which is a raw material for the support member 7 of the closing tape 5. The backup roller 18 pinches the base paper 16 with the gravure roll 17. The coating liquid pan 20 stores adhesive solution 19. The doctor blade 21 scrapes extra adhesive solution 19 from the periphery of the gravure roll 17.

The base paper 16 of the support member 7 is made of a long and wide paper material, set in the gravure coater 15 in a manner being wound up in a roll. The base paper 16 is pulled from the roll, passed between the gravure roll 17 and the backup roller 18, and the leading end thereof is locked by a winding up roller (not shown). According to rotation of the winding up roller in a winding direction, the base paper 16 is transported in an arrow direction shown in FIG. 4. Although not illustrated in the drawing, there is provided a drying device between the backup roller 18 and the winding up roller, for drying adhesive solution 19 being coated.

The roller-shaped gravure roll 17 is made of iron, on the periphery of which the multiple cells 25 and ridges 26 are formed by a corrosion method on periphery thereof. Moreover, chrome is plated on the cells 25 and ridges 26.

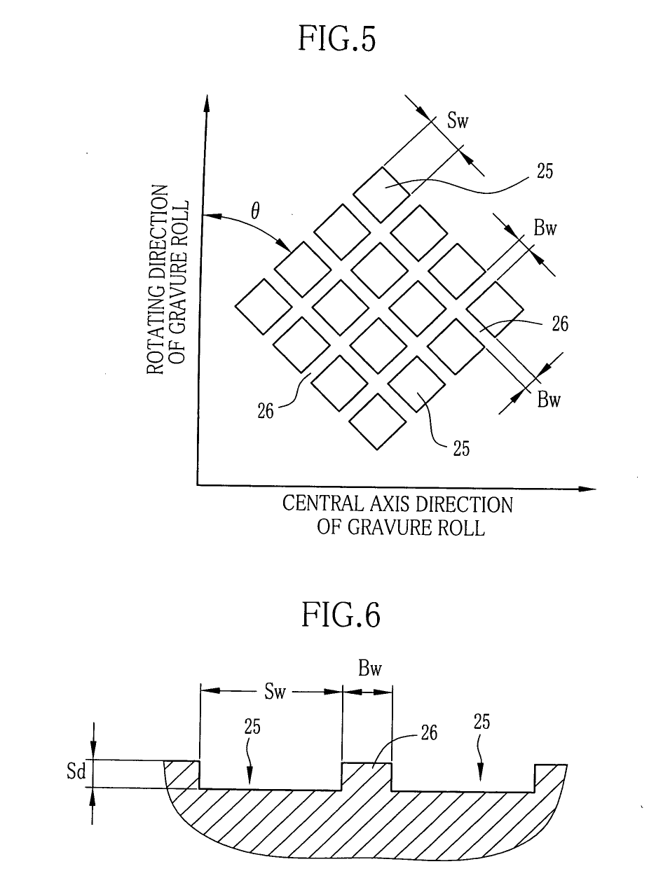

FIG. 5 is a partially exploded view of the cells 25 and ridges 26 on the gravure roll 17, in which a cross axis and a vertical axis respectively show a central axis direction and a rotating direction of the gravure roll 17. The cells 25 are formed square, for example 1 mm each side (Sw). Shown in a sectional view of the gravure roll 17 in FIG. 6, the cells 25 are for example 200 μm in depth (Sd). The width (Bw) of the respective ridges 26 which determine sizes of the cells 25 is approximately one fifth of that of the cells 25, for example 0.2 mm. The cells 25 are slantingly arranged at an angle θ, for example 45 degrees to a rotating direction of the gravure roll 17, in a similar manner with the cells for general use in photogravure.

The above gravure roll 17 is rotated by a motor (not shown) in a clockwise direction. A lower portion of the gravure roll 17 is dipped into adhesive solution 19 in the coating liquid pan 20. Accordingly, adhesive solution 19 is filled up in the cells 25 by rotation of the gravure roll 17. It is well known that the leading end of the doctor blade 21 is contacted on the periphery of the gravure roll 17, scraping off extra adhesive solution 19 deposited on the ridges 26 of the gravure roll 17.

Though not illustrated in detail in the figure, the backup roller 18 is rotatable, biased in a pressing direction to the gravure roll 17 by such as a spring. The backup roller 18 is rotated by following transportation of the base paper 16 and the rotation of the gravure roll 17, for pressing the base paper 16 on the gravure roll 17. A plurality of line-shaped heat sensitive adhesive layers are simultaneously coated on the wide base paper 16 by the gravure roll 17 and the backup roller 18. The doctor blade 21 is also disposed corresponding to the cells 25 of the gravure roll 17.

The adhesive solution 19 is produced by dissolving a heat sensitive adhesive in solvent and controlling the fluidity thereof. As a heat sensitive adhesive, a hot lacquer adhesive for example, “ECE-2” supplied by FUJI KASEI KOGYO CO., LTD. may be used. As a solvent, for example toluene may be used. The adhesive solution 19 is controlled to have relatively high viscosity, in order not to connect the adhesive dots 12 each other transferred from the respective cells 25 as a result of occurrence of flow after adhesive solution 19 is transferred on the base paper 16.

In order to obtain optimum viscosity of adhesive solution 19, experiments were conducted by coating the dots 12 by various viscosities of adhesive solution 19. Consequently, in a Zahn cup measuring method, it was found out that, in a manner of heating adhesive solution 19 at 50 degree, a running viscosity of 11 or more seconds and 14 or less seconds as measured using a No. 5 Zahn Cup viscometer was most suitable. The adhesive dots 12 were formed without connecting each other by using the above viscosity of adhesive solution 19. However, when using adhesive solution 19 with a running viscosity of 10 seconds in a Zahn cup measuring method, the adhesive dots 12 were flown after coating thereof, to connect with the adjacent dots each other. Moreover, in a use of adhesive solution 19 with a running viscosity of 15 seconds in a Zahn cup measuring method, the stringiness was generated at the coating, so that non-uniform transfer pattern of the dots 12 was likely to occur.

The above gravure coater 15 is operative as follows. The gravure roll 17 starts its rotation in a counterclockwise direction simultaneous with transportation of the base paper 16 in a clockwise direction shown in FIG. 4. During rotation of the gravure roll 17, adhesive solution 19 in the coating liquid pan 20 is filled up in the cells 25 on the periphery of the gravure roll 17, and extra adhesive solution 19 deposited on the ridges 26 is scraped off by the doctor blade 21. The adhesive solution 19 at the gravure coating is heated up to for example 50 degrees. The base paper 16 and the gravure roll 17 are pressed by pressure of the backup roller 18 and adhesive solution 19 in the cells 25 is transferred on the base paper 16.

Controlled to have relatively high viscosity, adhesive solution 19 in the cells 25 transferred on the base paper 16 is not flown out of the cells 25. Even if adhesive solution 19 is flown out of the cells 25, the dots 12 of adhesive solution 19 do not connect each other since the ridges 26 on the gravure roll 17 are as great as one tenth or more in width compared to the cells 25. The base paper 16 coated with adhesive solution 19 is wound up by the winding up roller after drying the adhesive solution 19 by the aforementioned drying device.

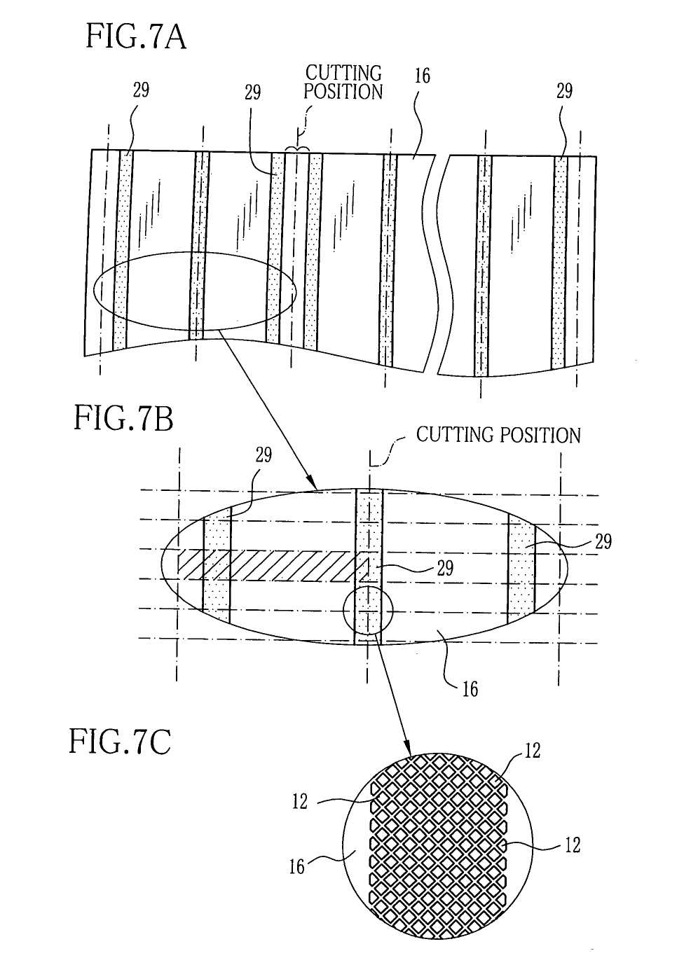

FIG. 7A is a plan view illustrating the base paper 16 on which line-shaped sensitive adhesive layers 29 are formed by the gravure coater 15. A plurality of line-shaped adhesive layers 29 is formed on the base paper 16 passed through the gravure coater 15. In FIG. 7C, the respective line-shaped adhesive layers 29 are formed with multiple adhesive dots 12. In FIG. 7B, the base paper 16 is cut at the position shown by a chain line at the same intervals in the both vertical and horizontal direction. Therefore, shown in the area with hatching of FIG. 2, one sheet of the closing tape or retaining tape 5 formed with the adhesive layers 8a and 8b on both sides thereof and the edge portion 7 on one end thereof is completed.

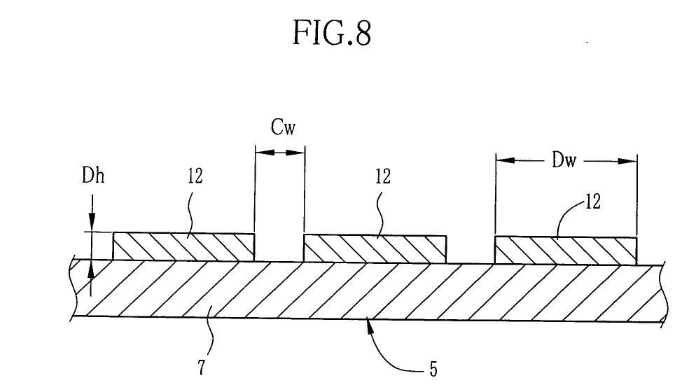

In FIG. 2, the completed closing tape 5 is formed with adhesive layers 8a and 8b constituted of the adhesive dots 12 in the coating areas 7a and 7b provided on both sides of the support member 7. The respective dots 12 are formed with square, 1 mm each side (Dw) according to a shape of the cell 25 of the gravure roll 17. The respective dots 12 have preferably an area of 0.5 mm² or more. Moreover, the respective dots 12 are 5 μm or more in thickness (Dh) as shown in the sectional view of the closing tape 5 in FIG. 8. Consequently, it is possible to obtain enough adhesive force from the respective dots 12. Furthermore, intervals (Cw) between the respective dots 12 are 0.2 mm according to width of the ridges 26, so that there never occurs unevenness of adhesive force due to connection of adjacent dots 12 each other at the time of adhesion.

Still furthermore, if the width (Fw) of the closing tape 5 and the width (Tw) of the coating area 7b are respectively 13 mm and 7 mm, the percentage of the total area coated by the adhesive dots 12 in the coating area 7b is approximately 64%. Even if compared to a closing tape coated with heat sensitive adhesive agent all over, the closing tape 5 can obtain enough adhesive force as a closing tape for a roll photo film. In addition, if the percentage of the total area coated by the adhesive dots in the total coating area is in the range of 55% or more and 93% or less, it is possible to obtain enough adhesive force and to individually arrange the respective dots.

As shown in FIG. 3, the closing tape 5 filled on the periphery of the roll photo film 2 is adhered to the periphery of the light-tight sheet 4 by the respective adhesive dots 12. Since the respective adhesive dots 12 are formed by the cells 25 of the gravure roll 17, the coating area and thickness are uniformized. Moreover, there occur no defects on the coating surface such as uneven thickness in the respective dots 12. Therefore, adhesive force of the respective dots 12 is uniformized, to stabilize adhesive force of the closing tape 5. Accordingly, the light-tight sheet 4 and the photo film can be sealed without winding looseness.

In the above embodiment, the example of the closing tape used for the roll photo film is explained. However, the present invention may be performed for other types of seal, tape or sticker. The present invention can be used not only for coating heat sensitive adhesive agent, but also for coating other types of adhesive agent. Moreover, the present invention is performed for a gravure coating. However, the present invention may be performed for other types of printing such as a silkscreen printing. Furthermore, it is to be understood that the present invention is not intended to be limited to the above-described embodiments such as a size and a coating thickness of the adhesive dots, and a size and a shape of the cells and ridges.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A method of producing an adhesive tape in which adhesive agent is coated on at least one surface of a support member, comprising the steps of:
applying said adhesive agent to a gravure coater having dotted pattern; and
pressing said support member to said gravure coater, to transfer dots of said adhesive agent to said support member.

2. A method of producing an adhesive tape as claimed in claim 1, wherein each of said dots of said adhesive agent corresponds to each cell of said gravure coater.

3. A method of producing an adhesive tape as claimed in claim 1, wherein said adhesive agent is heat sensitive adhesive agent.

4. A method of producing an adhesive tape as claimed in claim 3, further comprising the steps of:
keeping said adhesive agent at a viscosity, measured using a No. 5 Zahn cup viscometer, in a range from 11 to 14 seconds at the applying of said adhesive agent.

5. A method of producing an adhesive tape as claimed in claim 1, wherein said gravure coater includes plural ridges for partitioning cells adjacent each other, in which said rides have a width of one tenth or more of a width of each of the cells.

6. An adhesive tape produced by a producing method as claimed in claim 1, characterized in being adapted to sealing a strip-shaped photo film and a light-tight sheet which are wound around a spool.

7. A method of producing an adhesive tape for sealing a strip-shaped photo film and a light-tight sheet which are wound around a spool, said adhesive tape including a support member coated with adhesive agent on at least one surface thereof, said method of producing an adhesive tape comprising:
applying said adhesive agent to a gravure coater having dotted pattern; and
pressing said support member to said gravure coater, to transfer dots of said adhesive agent to said support member.

8. A method of producing an adhesive tape as claimed in claim 7, wherein each of said dots of said adhesive agent corresponds to each cell of said gravure coater.

9. A method of producing an adhesive tape as claimed in claim 7, wherein said adhesive agent is heat sensitive adhesive agent.

10. A method of producing an adhesive tape as claimed in claim 9, further comprising the steps of:
keeping said adhesive agent at a viscosity, measured using a No. 5 Zahn cup viscometer, in a range from 11 to 14 seconds at the applying of said adhesive agent.

11. A method of producing an adhesive tape as claimed in claim 7, wherein said gravure coater includes ridges for partitioning cells adjacent each other, in which said ridges have a width of one tenth or more of a width of each of the cells.
